(19) United States
(12) Patent Application Publication
(10) Pub. No.: US 2026/0242960 A1
(43) Pub. Date: Aug. 20, 2026

(54) RENEWABLE POWER TO X MODULE BASED ON OZONATION ASSISTED ELECTROCHEMICAL ENERGY CONVERSION REACTION

(71) Applicant: NewSouth Innovations Pty Limited, Sydney (AU)

(72) Inventors: Rahman DAIYAN, Sydney (BD); Rose AMAL, Sydney (AU); Emma LOVELL, Sydney (AU); Zhipeng MA, Sydney (AU)

(73) Assignee: NewSouth Innovations Pty Limited, Sydney (AU)

(21) Appl. No.: 19/472,331

(22) PCT Filed: Apr. 5, 2024
(86) PCT No.: PCT/AU2024/050326

§ 371 Date: Oct. 3, 2025

(30) Foreign Application Priority Data
Apr. 5, 2023 (AU) 2023901005

(51) Int. Cl. C25B 1/27; C01B 13/11; C01B 21/20; C25B 11/032; C25B 11/075; C25B 15/08

(52) U.S. Cl. CPC C25B 1/27; C01B 13/11; C01B 21/203; C25B 11/032; C25B 11/075; C25B 15/08; C01B 2201/62

(57) ABSTRACT

Methods for producing ammonia and/or ammonium comprising: i) ozonation of air to produce a product gas stream comprising ozone and gaseous NOₓ species, or using a waste stream comprising gaseous NOₓ species; and ii) electrolytically reducing the gaseous NOₓ species by passage from a gas side of a gas diffusion electrode to a catholyte thereby to produce NH₄+ or NH₃; and wherein the gas diffusion electrode comprises a metal/metal oxide single atom or dual atom catalyst electrode. Also, apparatus for carrying out the method, for example an ozone generator; and an electrolyser wherein the output of the ozone generator is fed to a catholyte of the electrolyser via a gas diffusion electrode.

### BACKGROUND TO THE INVENTION

The invention relates to methods and apparatus for the conversion of air into ammonia and ammonium salts, with ozone produced as a by-product and with minimal levels of waste products.

Any discussion of the prior art throughout the specification should in no way be considered as an admission that such prior art is widely known or forms part of common general knowledge in the field.

The transformation of atmospheric nitrogen (N₂) to ammonia (NH₃) is essential for many eco-systems and industrial processes. Currently, only bacteria and some plants can synthesize ammonia from air and water at ambient conditions via nitrogen fixation processes. Ammonia is an extremely valuable global commodity at present and appears likely to play a significant role not only in manufacturing but also in energy production, storage and transport as energy carrier in the near future.

Globally, approximately $60 billion worth of ammonia is produced every year for utilisation, mostly in the form of fertilizers. Recently, ammonia has been gaining increasing attention as a hydrogen carrier for the hydrogen economy. Ammonia stores almost twice as much energy as liquid hydrogen (by volume) and is easier to ship and distribute for export purposes. Thus, the global ammonia market has significant potential for expansion in upcoming years.

Ammonia used as fertiliser is currently produced via the large-scale capital-intensive and centralised Haber-Bosch (HB) process, which was developed in the early 20^{th} Century and has changed little in that time. In the HB process, hydrogen (generated from fossil fuel) and nitrogen (extracted from air) are converted to ammonia at a high pressure and temperature. As this process generates up to 2.4 Mt of CO₂ per tonne of NH₃, there is a clear market pressure to decarbonise this process as countries are increasingly committing to net-zero targets.

Decarbonization of agriculture and regional economy is dependent on the uptake of renewable electrification as well as “Power to X” (the conversion of electricity into power fuels or clean chemicals) pathways. Amongst these pathways, power to ammonia conversion, particularly in the form of decentralised modules, is projected to play a big role in attaining net-zero emissions as it will enable the reach of renewable electrons to substitute diesel consumption for mobility in mining and farming applications as well as providing zero-carbon fertilizer for agriculture. This potential of renewable ammonia is increasingly being recognized by industry and government, with a number of renewable hydrogen project developers in Australia and beyond substituting fossil-fuel sourced hydrogen with renewable hydrogen that is then used in energy-intensive Haber-Bosch (HB) process to generate renewable ammonia.

While such an approach allows operation of existing HB plants with modification (avoiding assets being stranded), this pathway requires high temperature and pressure-the HB process typically requires high pressures (150-250 atmospheres), high temperatures (400-500° C.), a relatively high purity hydrogen (from steam reforming of methane) feed and a relatively high purity nitrogen (from air separation) feed. Because of this, the HB process consumes a significant amount of energy and is fundamentally incompatible with small scale, delocalised ammonia production as well as making it unfeasible to accommodate intermittent and diffusive renewable energy, as the Haber-Bosch process operates in a dynamic manner and requires long-start up and shut down time. These challenges, coupled with the capital-intensive nature of the HB process, limit its use for decentralized on-demand production.

In recent times, there have been renewed research efforts into power-to-X pathways, including power-to-ammonia pathways, such as electrochemical N₂ reduction to NH₃ (NRR), waste NOx reduction to NH₃ (NOXRR) and plasma driven conversion of N₂ and H₂ to NH₃. However, these routes suffer from low product selectivity and yield, the requirement of suitable waste NOx feedstocks and high production costs. For instance, the highest yield arising from NRR and plasma conversion is 0.05 and 0.15 mmol h⁻¹ cm⁻², respectively, whereas NOₓRR yield is dependent on the concentration of NO₃⁻ and NO₂⁻ sources (highest yield of 1.2 mmol h⁻¹ cm⁻²). However, sources of NO₃ and NO₂⁻ sources are intermittent in agricultural water or rely on industrial point-source flue gas. With the transition of fossil fuel-based power generation, the available supply of industrial point source flue gas may be questionable in the long-term. The use of standalone plasma-electrolyser hybrids and Li-ion mediated NRR have exhibited promising increases in yield, however, questions on energy requirement and stability of electrodes for continuous cycling remain. There are also concerns on sourcing Li, a critical mineral, which will inevitably impede commercialisation of Li-ion mediated NRR pathway.

It is an object of the present invention to overcome or ameliorate at least one of the disadvantages of the prior art, or to provide a useful alternative.

### SUMMARY OF THE INVENTION

According to a first aspect the invention provides a method of producing ammonia and/or ammonium comprising:
i) ozonation of air to produce a product gas stream comprising ozone and gaseous NOx species; and
   ii) electrolytically reducing the gaseous NOx species by passage from a gas side of a gas diffusion electrode to a catholyte thereby to produce NH₄⁺ or NH₃; and wherein the gas diffusion electrode comprises a metal/metal oxide single atom or dual atom catalyst electrode.

The gaseous NOₓ species may pass through the gas diffusion electrode to and into a catholyte to produce dissolved NOₓ species which are reduced to provide NH₄⁺ and dissolved NH₃.

Partial dissolution of NOₓ species may take place prior to passage through the gas diffusion electrode, in which case it is introduced to the electrolyser as aqueous catholyte.

Any remaining undissolved NOₓ is involved in the reaction as gas phase input and undissolved NOₓ species are present in contact with the catholyte.

Dissolved NH₃ may pass from the catholyte through the gas diffusion electrode as gaseous ammonia. Similarly, NH₄⁺ in solution may also pass through the gas diffusion electrode. The dissolved NH₄⁺ or gaseous ammonia may be collected for use.

The NOₓ species may be in the gas phase and can comprise one or more of NO, N₂O and NO₂.

The dissolved nox may comprise both nitrate (NO₃⁻) And Nitrite (NO₂⁻) ions.

Ideally, the electrolysis is commenced when the concentrations of NO₃⁻ and NO₂⁻ are at a predetermined level and preferably the NO₃⁻ and NO₂⁻ are in a steady state equilibrium. In one embodiment, NO₃⁻ is present in a concentration of 1.7 mM and NO₂⁻ is present in a concentration of 10.0 mM when electrolysis is commenced, and thereafter for the duration of electrolysis.

The NOₓ species may be in both a gas phase and an aqueous phase, and wherein the gas phase comprises one or more of NO, N₂O and NO₂⁻ and the aqueous phase comprises one or more of nitrate and nitrite ions, and wherein the electrolyser is a flow electrolyser which receives the aqueous phase and the gas phase passed through a gas diffusion electrode.

The gaseous NOₓ may be reduced to NH₄⁺ the by contact with gas-diffusion-electrode (GDE), for example a Cu-based gas diffusion electrode.

The catholyte may be under an atmosphere comprising nox.

The ozone may be diverted for further use, for instance as a sterilizing agent for waste or contaminated water.

In another embodiment, the method of the present invention further includes introducing CO₂ to react with the produced ammonia. In this way, it is possible to form compounds having C—N bonds, for example, formamide and potentially urea.

According to a second aspect, the invention provides a method of producing ammonia and/or ammonium comprising:

i) obtaining a gaseous waste stream comprising gaseous NOₓ species; and
ii) electrolytically reducing the gaseous NOₓ species by passage from a gas side of a gas diffusion electrode to a catholyte thereby to produce NH₄⁺ or NH₃; and
wherein the gas diffusion electrode comprises a metal/metal oxide single atom or dual atom catalyst electrode.

The gaseous NOₓ species may pass through the gas diffusion electrode to and into a catholyte to produce dissolved NOₓ species which are reduced to provide NH₄⁺ and dissolved NH₃.

The NOₓ species may comprise one or more of NO, N₂O and NO₂⁻ and the dissolved NOₓ may comprise both nitrate (NO₃⁻) and nitrite (NO₂⁻) ions. Ideally, the electrolysis is commenced when the concentrations of NO₃⁻ and NO₂⁻ are at a predetermined level and preferably the NO₃⁻ and NO₂⁻ are in a steady state equilibrium.

According to a third aspect the invention provides an apparatus for ammonia production comprising:

an ozone generator; and
an electrolyser comprising a gas diffusion electrode according to the second aspect (or prepared by the third aspect); and wherein the output of the ozone generator is fed to a catholyte via the gas diffusion electrode.

In some embodiments, the output of the ozone generator is fed to the catholyte of the electrolyser directly as gas phase and aqueous phase.

The ozone generator is for preference a dielectric barrier discharge (DBD) ozone generator.

The apparatus may further include a feed unit, such as a fan or pump, to supply air to the module, said air being a feed gas for the ozone generator.

The gas diffusion electrode used in the present method (and apparatus) may comprise:
a support;
a conductive layer coated on the support;
a gas permeable membrane coated on the support, wherein the gas permeable membrane is impregnated with a metal/metal oxide single atom or dual atom catalyst.

The support may be for example graphite felt.

The conductive layer may be for example gold, and for example 100 nm thick.

The gas permeable membrane may be a cation conducting membrane, for example Nafion, or an Anion Exchange Membrane.

The gas permeable membrane supports a mixture of the flame sprayed single metal/metal oxide catalyst, such as pyrolyzed copper, and carbon black. The flame spray pyrolyzed copper may for example have a loading on the electrode of 0.1 mg/cm². Alternatively, the gas permeable membrane may support flame sprayed dual metal/metaloxide catalyst.

Any conventional support which has adequate chemical resistance to the conditions may be used, for example, the support may be graphite felt or PTFE.

The conductive layer may be for example gold, and for example 100 nm thick.

The gas permeable membrane may be Nafion.

The gas permeable membrane may be impregnated with a mixture of flame spray pyrolyzed copper and carbon black. The flame spray pyrolyzed copper may for example have a loading on the electrode of 0.01 to 1 mg cm⁻², for example 0.05 to 0.5 mg cm⁻² or 0.1 mg cm⁻².

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “volume %”, “ratio” will mean “volume ratio” and “parts” will mean “volume parts”.

The term ‘substantially’ as used herein shall mean comprising more than 50% by volume, mass or weight, according to the context is it used, unless otherwise indicated. Preferably, it is meant to mean more than 75%. Even more preferably, it is meant to mean more than 90%. Most preferably, it is meant to mean 100% or close to 100%.

The recitation of a numerical range using endpoints includes all numbers subsumed within that range (e.g., 1 to 5 includes 1, 1.5, 2, 2.75, 3, 3.80, 4, 5 etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

The invention will now be described, by way of example with reference to the accompanying drawings, in which:

FIG. 1 is a schematic of the ozonation-electrolysis process and apparatus of the present invention.

FIG. 2l shows NOₓ/O₃ production capability of a dielectric barrier discharge (DBD) ozonation system. (a) Gaseous NOₓ production rate (μmol min⁻¹) of the DBD ozonation reactor with different air flow rate. (b) Water-dissolved NOₓ (NO₃⁻) production rate under air flow rate of 4000 mL min- 1. (c) Comparing energy consumption of the current DBD system with various plasma reactor systems in producing NOₓ , such as single reactor glow discharge (SRGD); single reactor spark discharge (SRSD); single reactor glow and spark discharge (SRGSD); double reactor glow and spark discharge (DRGSD); and the current DBD system. (d) The DRIFTS spectra of gaseous O₃ under different air flow rate and I the quantified Os production rate (μmol min⁻¹).

FIG. 3 shows performance of integrated system for ammonium production. I-t curves are shown of Cu-based GDE tested using a flow-cell electrolyser with catholyte containing 10.0 mM NO_{2/1.7} mM NO₃⁻ (defined as the standard aqueous NOₓ equilibrium concentration) in 0.5 M K2SO 4 aqueous solution with (a) gaseous NOₓ input, (b) no gas input, and (c) air input under different applied potentials (V). Dependence of (d) Fl(e) jNH₄₊, and (f) NH₄⁺ production yield under different applied potentials. (g) I-t curves of Cu-based GDE tested using a flow-cell electrolyser under applied potential of- 2.5 V with catholyte containing 0 to 3 times of standard aqueous NOₓ⁻ equilibrium concentration with gaseous NOₓ input. (h) The dependence of FE, j_{NH4+}, and NH₄⁺ production yield on the aqueous NOₓ concentration under applied potential of-2.5 V. (i) The energy efficiency of the integrated ammonium production system under different applied potentials. (j) Ammonia production rate and energy consumption for our system and other NRR and NOₓRR systems in the literatures, i.e., conventional eNRR; Li-intermediary NRR; plasma-assisted NRR; NO₃RR; and NORR. (k) Operation mechanism of the present invention.

FIG. 4 shows the physicochemical characterizations and theoretical study. (a) SEM images of Cu-based gas-diffusion-electrode. (b-c) HR-TEM of Cu particles on as-prepared GDE. (d-g) MADDF-STEM image and EDX mappings of the catalysts. (h-i) In-situ PD measurements with Cu-based GDE under reaction conditions.

FIG. 5 shows the effect of the NOₓ atmosphere on the rate of ammonia production.

FIG. 6 shows the performance of the present invention when operated by a solar cell.

### DETAILED DESCRIPTION OF THE INVENTION

The skilled addressee will understand that the invention comprises the embodiments and features disclosed herein as well as all combinations and/or permutations of the disclosed embodiments and features.

To the best of the present inventors' knowledge, the present invention represents the first time that an ozonation apparatus and electrolytic reduction apparatus have been used in the production of ammonia. The use of such a combination allows for a high rate of production of ammonia from air in the presence of water with the only other requirement being renewable energy.

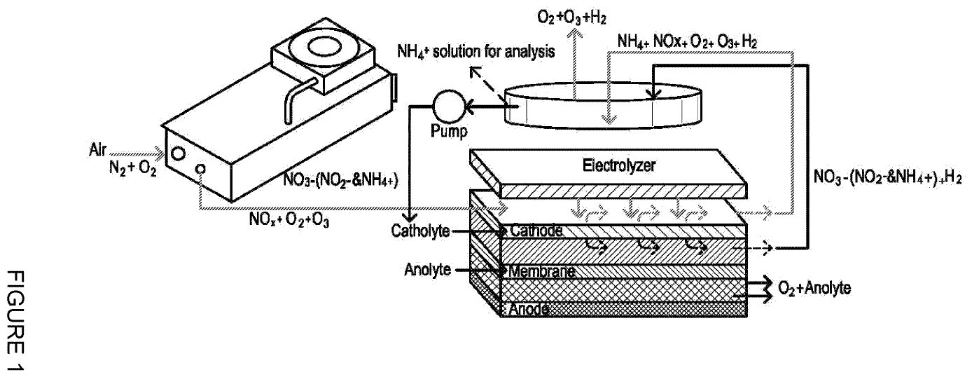

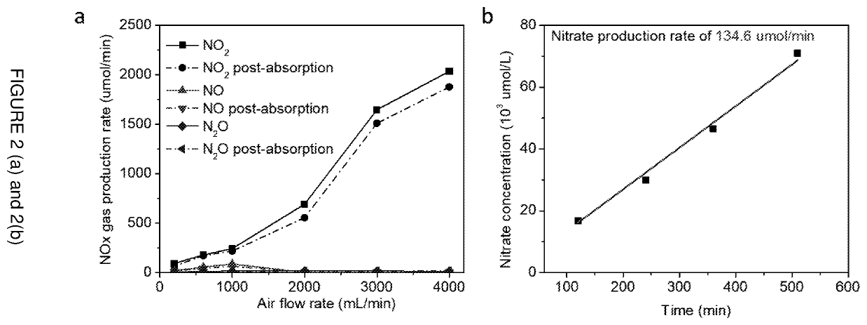

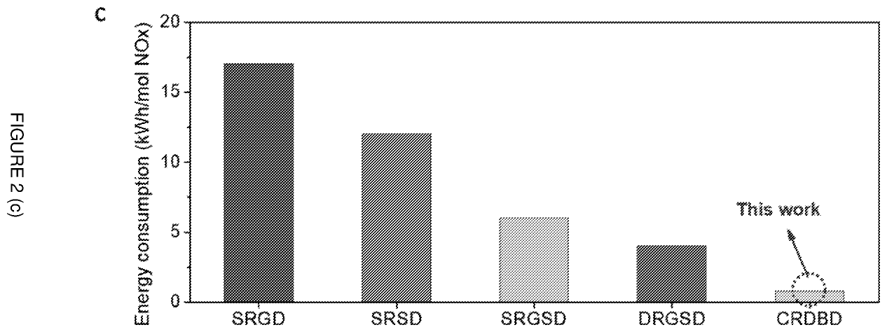

The apparatus itself is simple, scalable, and capable of continuous operation and shown in FIG. 1. The basic elements are a commercial dielectric barrier discharge (DBD) ozone generator coupled to an electrolyser, which receives the output from the ozone generator.

Air is taken in by the ozone generator, which converts air into gaseous O₃ and NOₓ , which can be directly introduced into a flow electrolyzer equipped with a Cu-based gas-diffusion-electrode (GDE) to transform the gaseous NOₓ into NH₄⁺.

Without wishing to be bound by theory, it is believed to be advantageous to use a DBD ozone generator because the mechanism of action of ozone formation and the presence of ozone is believed to assist in the oxidation of nitrogen to NOₓ species.

Further, it is believed that it is beneficial to include ozone in the electrolyser since this can assist in the suppression of potential undesired side reactions during generation of ammonia from NOₓ .

Further, the O₃ (which is unaffected by the electrolyser) and unreacted NOₓ can, if desired, be reused, for example, by being directed into irrigation water to reduce bacterial loads or providing a stream of dissolved nitrate in water for agricultural purposes.

Alternatively, if desired, the ozone treated wastewater solution can be pumped back into the electrolyzer as catholyte where it participates in the NH4+ production reaction on the Cu active sites from liquid side of Cu-based GDE. This can be repeated until the dissolved NOₓ species are, practically speaking, exhausted.

As such, the coupled ozonation electrocatalytic system of the present invention is capable for converting of air (N₂ and O₂) into reactive NOₓ species (both in the forms of gaseous NOₓ and ionic NOₓ⁻), which are further converted to ammonia at an efficient production rate.

Compared with the conventional electrochemical reduction of N₂, the present invention addresses both the low inherent solubility of N₂ in electrolyte solution and the high activation energy barrier for directly converting N₂ to NH₄⁺.

Compared to conventional ammonia synthesis techniques, the system of the present invention creates an NOx abundant environment around the catalyst, i.e., combined gaseous NOx and ionic NOx− reactants of equilibrium concentration under stable NOx input from ozone generator and NOx consumption by ammonium production at a metal-based GDE. This arrangement enables a high ammonia yield with high energy efficiency.

Overall, it can be seen that the present invention takes in air and renewable power, producing commercially useful products, namely NH₄⁺ (which can be used as a fertiliser, and ozone, a useful sterilising agent.

The apparatus and method can be operated in a continuous or intermittent manner without detriment.

Further, by adjusting the operation conditions, the balance between NH₄⁺ production and ozone production can be adjusted.

The device is thus particularly suited for a role in attaining net-zero emissions in agriculture and participating in independent regional economies as it enables the utilisation of renewable electrons to substitute fossil fuel consumption for mobility in mining and farming applications as well as provide net zero-carbon fertilizer for agriculture. Further, the scalable nature of this invention means this can potentially be used either as a standalone household module or as a large-scale facility to generate ammonium as hydrogen carrier for export.

In use, the apparatus successively converts air to nitrogen oxide intermediaries (NOₓ) and then to NH₄⁺ at ambient conditions with an energy efficiency of 90 kWh/kg of ammonia. Through modulation of system parameters, the present inventors have been able to achieve a maximum NOₓ production rate of 166.5 mmol h⁻¹ (8.1 mmol h⁻¹ in 0.5 M K₂SO₄ electrolyte and 158.4 mmol h⁻¹ in gas phase) and O₃ production rate of 2.9 mmol h⁻¹ using a 240 L h⁻¹ air flow rate. When adapted with an electrolyser with 1.2 L h⁻¹ flow rate, a high NH₄⁺ yield of ~1.3 mmol h⁻¹ cm² at a cell voltage of 2.5 V was achieved.

The flexibility of this coupled system for both wastewater treatment and ammonia production presents a pathway for decarbonisation of remote and regional applications.

The combination of a commercially available ozone generator with an electrolyser system to generate renewable ammonia requires significantly less energy input compared to hybrid plasma-electrolyser pathway and do not require critical minerals which will hinder scale-up, for example alternative approaches which rely heavily in the use of Li intermediary NRR solutions. By converting both NOₓ intermediaries in gas phase and liquid phase, this invention allows attaining of high production rates with good efficiency.

An important first step in the process of the present invention is the generation of O₃ and NOₓ species. In this case, a commercial DBD ozone generator (BMT 803N) was used. Similar DBD ozone generators from other manufacturers can also work well for this system, such as 3S-710 (Beijing Tonglin), POZN-10 (Qingdao Pioneer), BF-XD-35 (Suzhuo Jingtuo), CBR2-25G-B1 (Jindawanxiang), MAT Cold plasma ozone generator (MAT Ozone Technology). The effect of inlet air flow rate supplied to the ozone generator upon the production rate of NOₓ and O₃ species was determined using combined gas chromatography-mass spectrometry (GC-MS) and ultraviolet-visible (UV-vis) spectroscopy techniques.

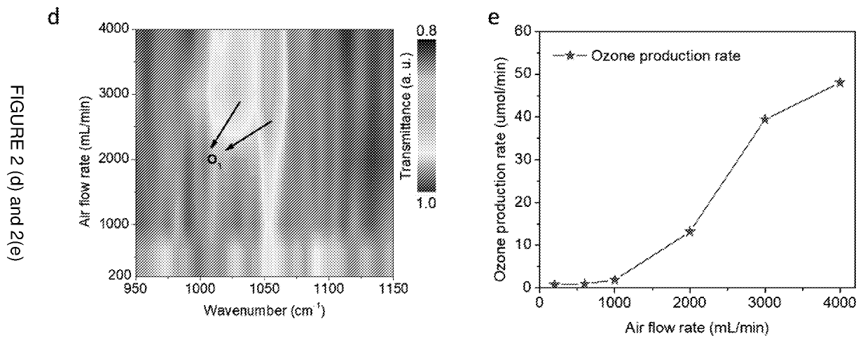

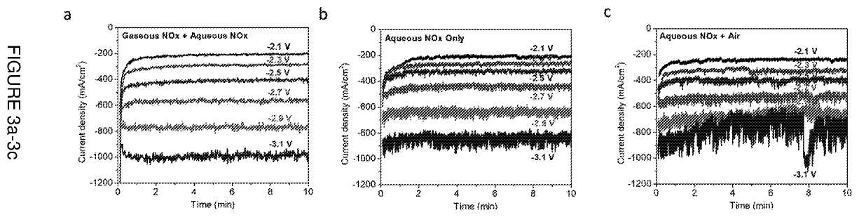

The ozone generator-produced gaseous NOₓ is composed primarily of N₂O, NO, and NO₂. The exact composition and production rate of which are dependent on the input air flow rate as indicated in FIG. 2a. Specifically, the gaseous NO₂⁻ production rate increased from 94.4 μmol min⁻¹ to 2034.2 μmol min⁻¹ when the air flow rate increases from 200 mL min⁻¹ to 4000 mL min⁻¹. For gaseous NO production, the production rate increases linearly from 19.9 μmol min⁻¹ to 87.5 mol min⁻¹ with the air flow rate ranging from 200 mL min⁻¹ to 1000 mL min⁻¹, however, the NO production rate dramatically drops to 2.1 μmol min⁻¹ when the air flow rate reaches 2000 mL min⁻¹. Further increase in air flow rate to 3000 mL min⁻¹ and 4000 mL min⁻¹does not significantly change the NO production rate. As for the N₂O production rate, that is 5.1 μmol min⁻¹ at air flow rate of 200 mL min⁻¹, which increases to 13.1 μmol min⁻¹ to 17.4 umol min⁻¹ with air flow rate ranging from 600 mL min⁻¹ to 4000 mL min⁻¹. In addition, it is noted that the gaseous NOₓ production rate in the off gas from an absorption tank filled with 1 L 1.0 M K₂SO₄ aqueous solution decreases compared with the off gas directly collected from the ozone generator, indicating that the gaseous NOₓ is being partly absorbed in the aqueous solution. Hence, the amount of ionic NOₓ species from NOₓ absorption were analyzed and quantified using UV-vis measurement, which confirmed that only nitrate (NO₃⁻) was produced without nitrite (NO₂⁻) formation.

The kinetic investigation of the nitrate production with 4000 mL min⁻¹ air input is shown in FIG. 2b, the NOₓ production rate can be observed to increase linearly with a production rate of 134.6 umol/min. These results validate the practicality of using an DBD ozone generator to produce both gaseous and ionic NOₓ from air. The commercial DBD ozonation system outperformed the single reactor glow discharge (SRGD), single reactor spark discharge (SRSD), single reactor glow and spark discharge (SRGSD), and double reactor glow and spark discharge (DRGSD) regarding its energy consumption required for 1 mol NOₓ production, i.e., 0.8 kwh/mol Nox. Therefore, the DBD ozonation system with efficient NOₓ production capability builds a platform for subsequent production of NH₄⁺ through electrolysis.

In addition to NOₓ production from air, the DBD system simultaneously produces ozone. Diffuse reflectance infrared Fourier transform spectroscopy (DRIFTS) was used to detect and quantify the ozone produced from the DBD ozonation system. See FIG. 2c for comparison.

The off gas from the ozone generator with varied air input flow rate ranging from 200 mL min⁻¹ to 4000 mL min 1 was led into the in-situ DRIFTS cell, which is connected to the FTIR spectrometer (Bruker VERTEX 70v) for the collection of spectra. As shown in FIG. 2d, two features at ~1020 cm⁻¹ and 1055 cm⁻¹ were attributed to the O₃ species, the signal of which was significantly enhanced when the air input flow rate increased from 200 mL/min to 4000 mL/min, indicating higher O₃ production rate with increased air input. The O₃ production rate under different air flow rate was further quantified based on the obtained in-situ FTIR spectra, which was plotted in FIG. 2e. It is noted that the O₃ production rate could be enhanced from 0.7 μmol min⁻¹ to 48.0 μmol min⁻¹ by improving the air input flow rate. The O₃ production enhancement was more significant when air flow rate reaches >1000 mL min⁻¹, which is consistent with the improvement in gaseous NO₂⁻ production rate. This suggests that amount of O₃ in the ozonation system is important to promote NOₓ production toward NO₂. Additionally, the capability of Os production at the level of 48.0 μmol min⁻¹ makes the ozonation system an efficient tool in killing bacteria when utilized in treating the irrigation water for agricultural production.

The DBD ozone generator treated water with aqueous phase NOₓ was then mixed with 0.5 M K₂SO₄ and fed as catholyte into the electrolyzer alongside gas phase NOₓ generated from the ozone generator. The choice of SO₄ containing electrolyte solution also ensures that the end NH₄⁺ as ammonium sulphate, a common fertilizer with a market value of USD $1.08 billion in 2021.

Within the electrolyzer, a gas-diffusion-electrode (GDE) is located. This gas diffusion electrode is prepared with Au sputtered polytetrafluoroethylene (PTFE) coated graphite felt as substrate and Cu deposited nanoparticles prepared using a flame spray pyrolysis (FSP) method as catalyst (details below), which is used as the cathode whereas a commercial Ni foam is used as the anode. The anode and cathode were separated by an anion exchange membrane (Sustainion®, Dioxide Materials).

The anode was separated from the anion exchange membrane by KOH anolyte (1.0M) whereas the cathode was separated by 0.5 M K₂SO₄ as catholyte as described above. The present inventors have found that in order to achieve good selectivity and yield of NH₃ from the present invention, it is important to have the dissolved NOₓ species (particularly NO₂⁻ and NO₃) present in an equilibrium concentration.

Equilibrium can be reached by pre-purging the catholyte with ozonation output until the desire equilibrium is achieved. This is the preferred approach as no additional chemical dosing is required, the ozonation apparatus is simply run for a time prior to commencing reduction.

Alternatively, the reaction can be forced to equilibrium more quickly by the addition of a suitable NO₃⁻ source.

Once equilibrium is reached, it can be maintained by balancing the rate of NOₓ production from the ozonation apparatus with the rate of aqueous NOₓ conversion in the electrolytic reduction cell. In this manner, the apparatus can be operated to achieve maximum NH₄⁺ production.

In addition, the present inventors have found that it is important to have a high gaseous NOₓ atmosphere in contact with the aqueous NOₓ solution in order to maximise NH₄⁺ yield.

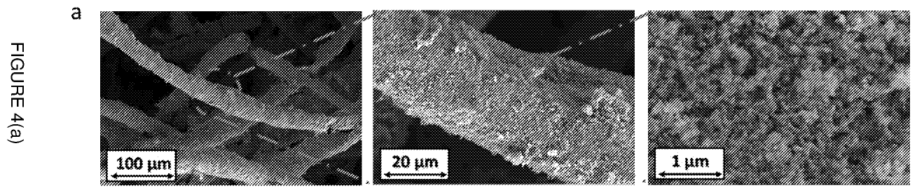

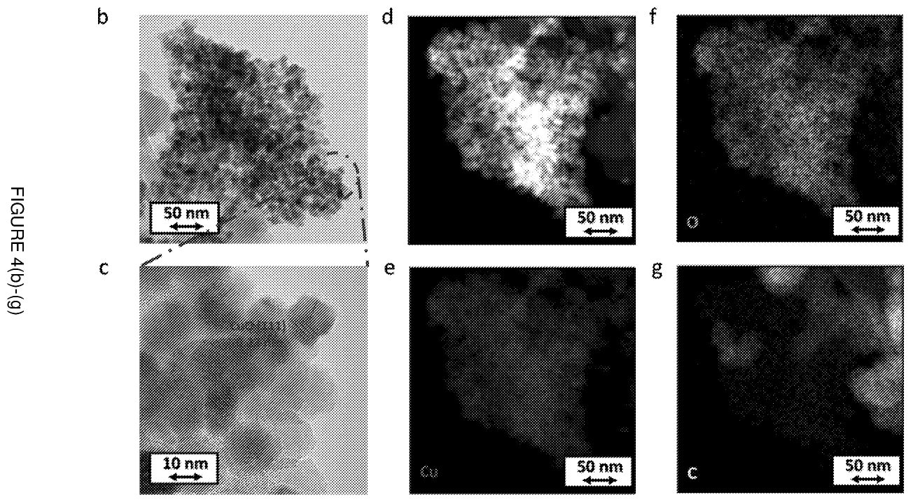

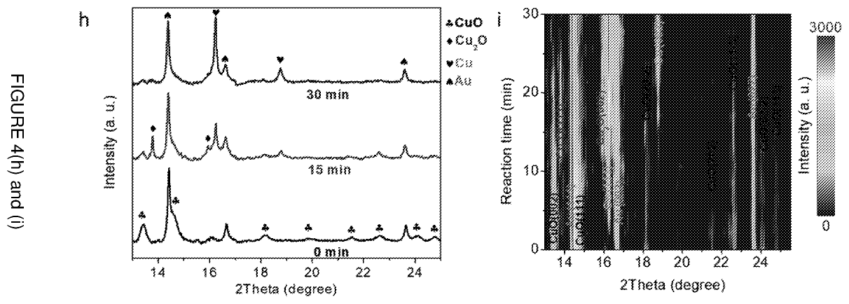

Without wishing to be bound by theory, the high gaseous NOₓ production is believed to assist in maintaining the desired aqueous equilibrium which maximises NH₄⁺ yield. This is illustrated in FIG. 5.

The catalysts that can catalyse this reaction include Copper, Bismuth, Tin, Iron and Zinc and their oxides, Copper-Bismuth oxides, Copper-Tin oxides, Copper-zinc oxides, copper-iron oxide, Copper-Bismuth-Tin oxides, Cu single atom catalysts, Bi single atom catalysts, Tin single atom catalysts, Zn single atom, Iron single atom, or combinations of these single atoms (dual atom catalysts). The catalysts can be plasma-treated to induce defects. The single atom catalysts may have atoms that are clustered together and may be present as atomic cluster catalysts.

The catalyst loading can range from 0.1 mg cm² to 5 mg cm² with the electrodes can be drop-casted or directly prepared on the substrates using FSP for the case of metal oxide catalysts.

The mixed oxide metals can be prepared using wet-chemistry method, flame spray pyrolysis and thermal spraying techniques. Single atom catalysts/atomic cluster catalysts/dual atom catalysts can be prepared using wet chemistry techniques. The substrates can be carbon fiber paper, graphite felt, PTFE, Titanium mesh, platinized titanium mesh, Copper foam, Nickel foam, etc.

The conductive layer can be gold, silver, etc. or any other suitably inert conductor.

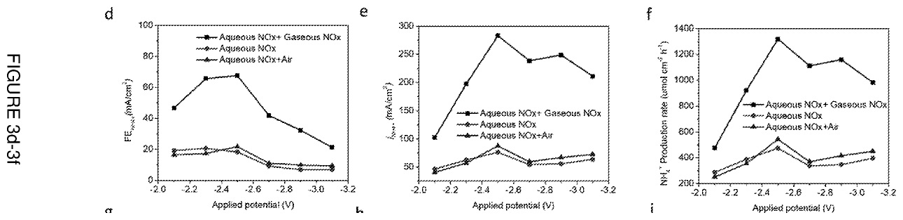

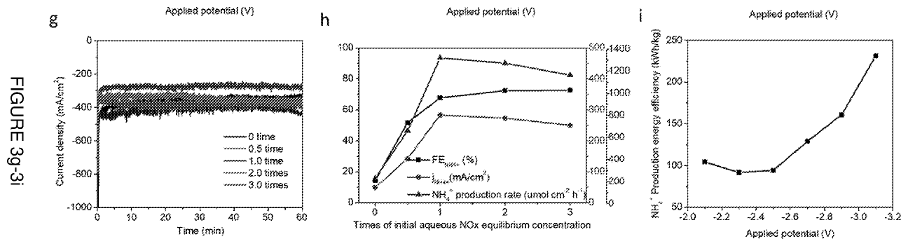

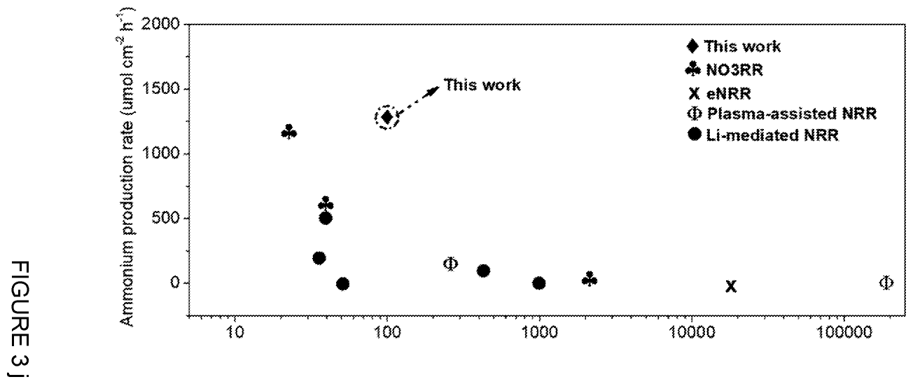

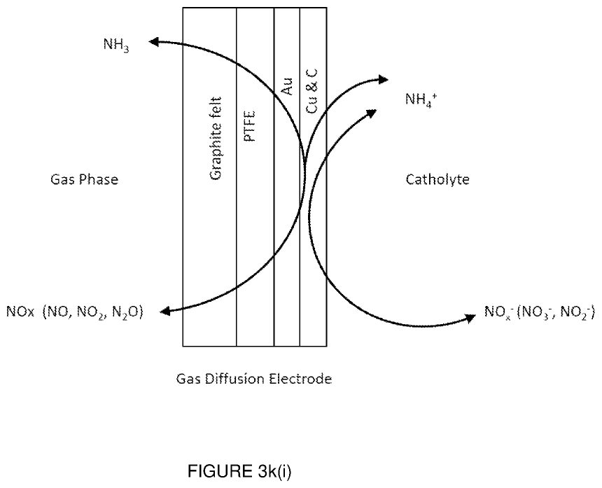

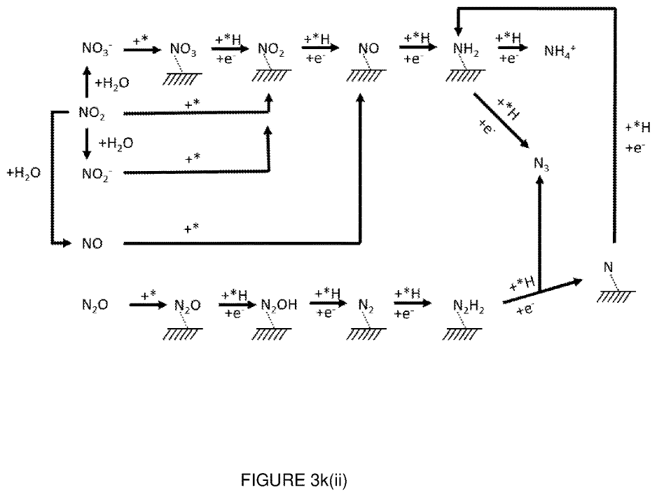

The linear sweep voltammetry (LSV) curve over the Cu-based GDE in the electrolyzer with NOₓ supplied by the DBD ozone generator is shown in FIG. 3a, displaying a current density (j) of ~400 mA cm⁻² at an applied potential of −2.5 V, while j of ~1000 mA cm⁻² at an applied potential of −3.2 V. Constant electrolysis at fixed potentials ranging from −2.1 V to −3.1 V, was then carried out, with the respective current density displayed in FIG. 3b, showing that more negative applied potential resulted in improved current density. Additionally, the stable current density during the measurement indicated the good stability of the catalyst and coupled ozonation-electrolyzer system. Moreover, it is noted that increasing cathodic potential from −2.1 V to −2.5 V leads to an increase in Faradaic efficiency of NH₄⁺ (FE_{NH4 +}) from 46.6% to 67.6% (FIG. 3c). Nevertheless, the FENH₄⁺ decreases with more negative applied potential from −2.7 V to −3.1 V, i.e., 41.9% and 21.3%, respectively. Additionally, the highest current density toward NH₄⁺ (j_{NH4 +}) reached 283 mA cm⁻² at −2.5 V, which corresponds to the highest NH₄⁺ production rate of 1320 μmol cm⁻² h⁻¹(FIG. 3d). By adding up the energy consumption for NOₓ production and electrochemical NH₄⁺ production, the total energy consumption (kWh) for producing 1 kg NH₄⁺ is plotted according to the applied potentials (from −2.1 V to −3.1 V). Specifically, the coupled ozonation-electrolysis system operated the most efficiently under applied potentials at −2.3 V and −2.5 V, achieving energy consumption of 91.7 and 94.2 kWh for producing 1 kg NH₄⁺, respectively.

The high NH₄⁺ production rate and low energy consumption of the coupled ozonation-electrolysis system make it attractive among the reported electrolysis-based ammonia production techniques, such as the nitrate reduction reaction (NO₃RR), direct electrochemical nitrogen reduction reaction (eNRR),8 plasma-assisted NOₓ reduction reaction (plasma-assisted NOₓRR) and Li-mediated nitrogen reduction reaction (Li-mediated NRR). (FIG. 3e). In addition to the relatively low energy consumption of the DBD ozone generator for producing NOₓ , it is postulated that the co-feed of gaseous NOₓ (NO, N₂O, and NO₂) together with the ionic NOₓ (NO₃⁻ and NO₂) to the Cu catalysts in the electrolyzer set-up also plays an important role in promoting the NH₄⁺ production while contributed to the energy efficiency of the coupled system. (FIG. 3f).

I-t curves of Cu-based GDE were tested using a flow-cell electrolyser under applied potential of −2.5 V with catholyte containing 0 to 3 times of standard aqueous NOₓ equilibrium concentration with gaseous NOₓ input (FIG. 3g).

As indicated in FIG. 3h, when the NOₓ equilibrium concentration is low, current density and efficiency are low. Increasing the NOₓ equilibrium to a certain level maximizes the NH₄⁺ production rate, however, exceeding that ratio, not only is not further benefit achieved, but in fact a decrease in ammonia production is observed. The optimal initial aqueous NOₓ concentration for maximum NH₄⁺ rate was found to be 10.0 mM NO₂/1.7 mM NO₃. It can be seen that at 0.5 times this concentration, the production rate is sufficiently less, whereas doubling or even tripling the concentration leads to a diminished NH₄⁺ production rate.

FIG. 3(i) The energy efficiency of the integrated ammonium production system under different applied potentials.

FIG. 3(j) shows the Ammonia production rate and energy consumption for the present system compared to other NRR and NOₓRR systems described in the literature i.e., conventional eNRR; Li-intermediary NRR; plasma-assisted NRR; NO₃RR; and NORR.

It is to be noted that in the prior art, a carrier gas is typically required in order to assist in the dissolution of NOₓ species prior to reduction. However, the present invention uses ozone to generate suitable gas species which can directly dissolve in aqueous solutions. The present invention requires no additional gas source other than the air that is consumed by the ozone generating apparatus.

Without wishing to be bound by theory, the movement of species across the membrane, between the gaseous feed side and the catholyte, when the device is in operation is shown in FIG. 3k(i). Again, without wishing to be bound by theory, FIG. 3k(ii) shows the mechanistic steps at the catalyst surface during the electrolytic reduction of NOₓ species.

The Cu based GDE was characterized by a combination of ex-situ and in-situ characterization techniques. The SEM images of the Cu-based GDE is shown in FIG. 4a, indicating that the Cu particles are deposited on the carbon fiber structures.

The high-resolution TEM (HR-TEM) images (FIGS. 4b-c) shows the Cu catalyst is present as CuO particles (with lattice distance of 0.23 nm attributed to CuO(111) facet) with diameter of 10 to 20 nm and the HAADF-STEM images (FIG. 4d) and STEM-EDS maps (FIGS. 4f-g) further confirms the Cu catalysts are in the form of CuO (well dispersed Cu and O elements) and surrounded by the carbon black.

To further study the Cu catalyst properties under reaction conditions, the synchrotron-based in-situ powder diffraction (PD) experiments were conducted in a custom-built in-situ cell equipped with the as-prepared Cu-based GDE as working electrode for electrochemical ammonia production. The cell is filled with aqueous electrolyte containing 0.1 M KNO₃ and 0.5 M K₂SO₄ and operated at −200 mA/cm² for 30 min, while the PD spectra was collected per 5 min. The spectra collected at 0 min, 15 min, and 30 min are shown in FIG. 4h. Specifically, all spectra exhibited the characteristic peaks of Au (111), Au (002), and Au (022) (COD code: 96-901-2431), which are attributed to the sputtered Au in the substrate.

For the catalysts prior to reaction (0 min), the catalysts exhibited a series CuO characteristic peaks, i.e., CuO (002), CuO (111), CuO (20-2), CuO (202), CuO (11-3), CuO (02-2), and CuO (113) (COD code: 96-101-1149). For the spectrum collected after 15 min reaction, the characteristic peaks of Cu₂O (111), Cu₂O (002), Cu (111), and Cu (002) (COD code: 96-900-7498 and 96-710-1265, respectively) appear with intensity decrease of afore-mentioned CuO characteristic peaks. This suggests the partial reduction of the original CuO phase to CuzO and Cu species during the reaction. Interestingly, the PD spectrum of the catalyst after 30 min only exhibited Cu species attributed to metallic Cu while no Cu₂O and CuO were detected. This proves that the catalysts would be stable in metallic Cu phase during the reaction.

### Materials

All chemical reagents and solvents utilized in this work were used as received and without any further purification. Deionized water (resistivity 18.2 MΩ cm⁻¹) was used in all experiments.

### Catalyst Synthesis

The Cu-based catalyst was synthesized using a flame spray pyrolysis (FSP) method. A copper precursor solution comprised of copper 2-ethylhexanoate (Sigma-Aldrich, 92.5-100%) in xylenes (Sigma-Aldrich, reagent grade) was prepared in a manner that the Cu concentration in solution was 0.5 M. This precursor solution was fed to the FSP system with a flow rate of 5 mL min 1 using a syringe pump and was atomized using an oxygen flow of 5 mL min 1 (Coregas, 99.9%). The flame was ignited and maintained with a supporting flame mixture which consisted of 3.2 L min⁻¹ oxygen and 1.5 L min⁻¹ methane (Coregas, 499.95%). The flame was directed with the aid of a 5 L min⁻¹ flow of oxygen and a vacuum pump toward a glass fiber filter, where the CuO nanomaterials were deposited and collected. Then, the synthesized Cu catalyst powder was mixed with carbon black with a weight ratio of 1:1 in ethanol aqueous solution (volume ratio of ethanol and water was 1:1), where the Nafion solution (5 % wt.) was added in to achieve Cu catalyst and Nafion weight ratio of 10:1. The as-prepared Cu/carbon/Nafion ink was sprayed onto an Au-coated graphite felt (graphite thickness of 4.7 mm with 100 nm gold layer) to construct the gas diffusion electrode. The loading Cu catalysts is controlled to be 0.1 mg cm².

### Nox Production Experiments

The NOₓ production experiment was conducted using ozone generator (BMT 803N) under operating power of 135 W. The feed gases for NOₓ production are air and O₂, the flowrates of which are controlled by gas flowmeters in a range of 0.2 to 4.0 L min⁻¹.

### Electrochemical Experiments

All electrochemical measurements were carried out using an Autolab potentiostat PGSTAT204 (Methrohm) equipped with a current/voltage booster (Booster10A). The Cu-based GDE was applied as the working electrode for a customized two-electrode flow-cell electrolyzer, while the Ni foam was used as the counter electrode. The counter electrode and working electrode was separated using an anion-exchange-membrane (AEM, Dioxide Materials). The electrolyzer used 1.0 M KOH as anolyte while used 0.5 M K₂SO₄ as catholyte, respectively at a flow rate of 9.5 mL min⁻¹. Note all j reported herein is normalized to the geometric surface area without any iR compensation.

### Product Analysis

Post-reaction, 0.5 mL of catholyte was collected for analysis using indophenol-blue test to determine NH₄⁺ concentration. The catholyte was pipetted into a 1.5 mL sample tube followed by the addition of (i) 0.4 mL of 1M sodium hydroxide solution (Sigma Aldrich, 99.99%) that consists of 5 wt. % salicylic acid (Sigma Aldrich, 99.99%), 5 wt. % sodium citrate (Sigma Aldrich, 99.99%), (ii) 0.1 mL of 0.05M sodium hypochlorite solution (Sigma Aldrich, 99.99%)) and (iii) 30 μL of 1 wt. % sodium nitroferricyanide solution ((Sigma Aldrich, 99.99%), sonicated thoroughly and incubated in the dark at room temperature for a duration of two hours. Dilution of the electrolyte was required as ammonia concentration was high. Afterwards, a Shimadzu UV-3600 UV-vis-NIR spectrophotometer was employed to quantify the amount of ammonia being produced from the electrocatalysis process. The absorbance readings between 550 to 850 nm wavelengths were measured. By using the peak absorbance reading, the performances of all catalysts in generating ammonia were assessed in terms of Faradaic efficiency, and ammonia yield.

### Physical Characterization

The morphology of CuO was investigated using a scanning electron microscope (FEI Nova NanoSEM 450 FE-SEM) and a high-resolution transmission electron microscope (HR-TEM) JEOL 2100F operating at 200 kV. XRD was carried out using PANalytical X'Pert instrument using Cu K∝ radiation (λ=1.54 Å) with a scan range from 10° to 90° . Surface chemical composition was evaluated using XPS with a Thermo ESCALAB250i X-ray photoelectron spectrometer. To prepare the working electrode, a catalyst ink was prepared by dissolving 1.25 mg of CuO in 0.5 mL of deionized water, 0.5 mL of ethanol and 50 μl Nafion® 117 solution (~5% Nafion) by sonication. The catalyst ink was drop-casted on the working area on the =and dried overnight (catalyst loading: ~0.1 mg cm⁻²).

### Energy Requirements

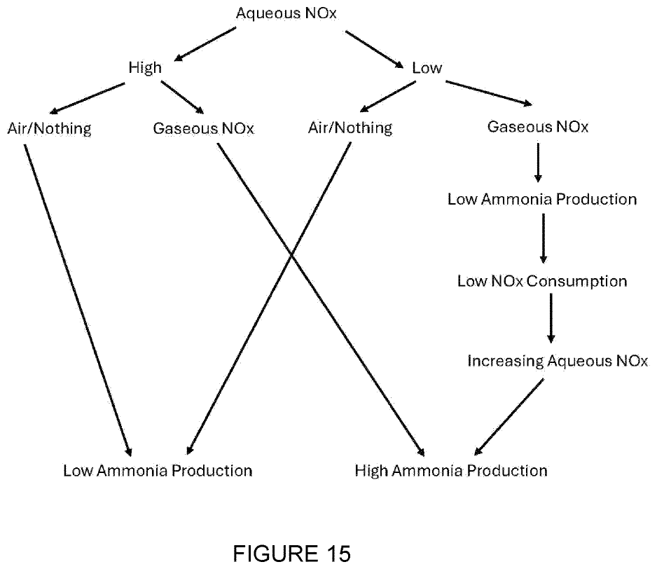

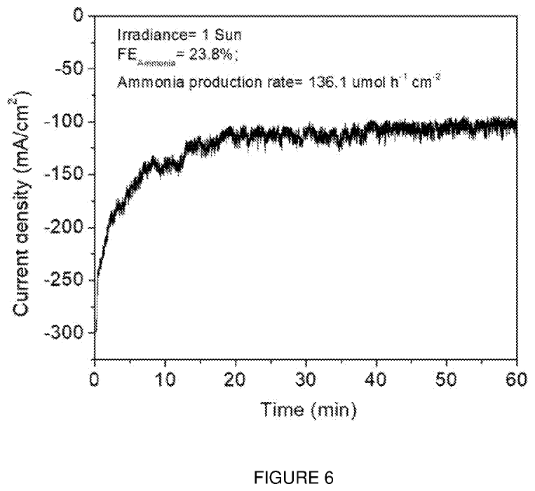

The relatively low energy consumption of this coupled ozonation-electrolysis system enables effective operation to be carried out under solar power alone. Experiments have shown an encouraging ammonia production of 136.1 μmol cm⁻² h⁻¹ was achieved when the apparatus was powered by a photovoltaic panel under 1 Sun irradiance. FIG. 6 shows the ammonia production performance of the Cu GDE in coupled ozonation-electrolysis system powered by a photovoltaic panel under 1 Sun irradiance.

1. A method of producing ammonia and/or ammonium comprising:
i) ozonation of air to produce a product gas stream comprising ozone and gaseous NOₓ species; and
ii) electrolytically reducing the gaseous NOₓ species by passage from a gas side of a gas diffusion electrode to a catholyte thereby to produce NH₄⁺ or NH₃; and
wherein the gas diffusion electrode comprises a metal/metal oxide single atom or dual atom catalyst electrode.

2. A method of producing ammonia and/or ammonium comprising:
i) obtaining a gaseous waste stream comprising gaseous NOₓ species; and
ii) electrolytically reducing the gaseous NOₓ species by passage from a gas side of a gas diffusion electrode to a catholyte thereby to produce NH₄⁺ or NH₃; and
wherein the gas diffusion electrode comprises a metal/metal oxide single atom or dual atom catalyst electrode.

3. A method according to claim 1 wherein the gaseous NOₓ pass through the gas diffusion electrode to and into a catholyte to produce dissolved NOₓ species which are reduced to provide NH₄⁺ and dissolved NH₃.

4. A method according to claim 1 wherein undissolved NOₓ species are present in contact with the catholyte.

5. A method according to claim 1 wherein the gaseous NOₓ species comprise one or more of NO, N₂O and NO₂.

6. A method according to claim 1 wherein the dissolved NOₓ comprises nitrate (NO₃⁻) and nitrite (NO₂⁻) ions.

7. A method according to claim 6 wherein the NO₃⁻ and NO₂⁻ are in a steady state equilibrium.

8. A method according to claim 1 wherein electrolysis is commenced when the concentrations of NO₃⁻ and/or NO₂⁻ are at a predetermined level.

9. A method according to claim 7 wherein NO₃⁻ is present in a concentration of 1.7 mM and/or NO₂⁻ is present in a concentration of 10.0 mM when electrolysis is commenced.

10. A method according to claim 7 wherein NO₃⁻ is present in a concentration of 1.7 mM and NO₂⁻ is present in a concentration of 10.0 mM thereafter for the duration of electrolysis.

11. A method according to claim 1 when the catholyte is under an atmosphere comprising NOₓ .

12. A method according to claim 1 wherein the ozone is diverted for use.

13. A method according to claim 1 wherein the ozonation of air is by dielectric barrier discharge.

14. A method according to claim 1 further including introducing CO₂ to react with the produced ammonia.

15. A method according to claim 1 wherein the metal/metal oxide single atom or dual atom catalyst electrode is selected from one or more of Cu single atom catalysts, Bi single atom catalysts, Tin single atom catalysts, Zn single atom, Iron single atom, CuBi, CuSn, CuZn, CuFe, BiSn, BiZn, BiFe, SnZn, SnFe, ZnFe dual atom and/or oxides thereof.

16. An apparatus for ammonia production comprising:
an ozone generator; and
an electrolyser and wherein the output of the ozone generator is fed to a catholyte of the electrolyser via a gas diffusion electrode.

17. An apparatus according to claim 16 wherein the output of the ozone generator is fed to the catholyte of the electrolyser directly as gas phase and aqueous phase.

18. An apparatus according to claim 16 wherein the ozone generator is a dielectric barrier discharge (DBD) ozone generator.

19. (canceled)

20. (canceled)

21. A method according to claim 2 wherein the gaseous NOₓ pass through the gas diffusion electrode to and into a catholyte to produce dissolved NOₓ species which are reduced to provide NH₄⁺ and dissolved NH₃.
